(19) United States
(12) Patent Application Publication
(10) Pub. No.: US 2010/0035478 A1
(43) Pub. Date: Feb. 11, 2010

(54) ELECTRICAL CONNECTORS FOR STORAGE DEVICE

(75) Inventors: SHENG-HO YANG, Tu-Cheng (TW); TSU-YANG WU, Tu-Cheng (TW); BIN PAN, Irvine, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/539,564

(22) Filed: Aug. 11, 2009

(30) Foreign Application Priority Data
Aug. 11, 2008 (TW) 97214369

(51) Int. Cl. H01R 24/00

(52) U.S. Cl. 439/638

(57) ABSTRACT

An electrical connector (2, 3) provides an interface compatible with an internal micro Serial ATA connector. The electrical connector (2, 3) includes an insulated housing (21, 31), a first number of contacts (221, 222, 223, 321, 322, 323) assembled to the insulated housing (21, 31); and a second number of contacts (224, 225, 324, 325) assembled to the insulated housing (21, 31). The first number of contacts (221, 222, 223, 321, 322, 323) constitute a power segment and a signal segment compatible with the internal micro Serial ATA connector. The second number of contacts (224, 225, 324, 325) is used for mating with a new type of mating connector (3, 2) when higher transfer speed is needed.

### CROSS-REFERENCE TO RELATED APPLICATIONS

The subject matter disclosed herein is related to the subject matter disclosed in pending U.S. patent application Ser. No. 12/288,143, filed on Oct. 16, 2008 and entitled “ELECTRICAL CONNECTORS FOR STORAGE DEVICE”, which is assigned to the same assignee as this application.

### BACKGROUND OF THE INVENTION

1. Field of the Invention

The present invention generally relates to an electrical connector, and more particularly to an electrical connector providing an interface for a storage device.

2. Description of Related Art

The Serial ATA International Organization published a proposed Serial ATA draft specification of revision 0.70 on 21 Sep. 2006. The Serial ATA draft specification disclosed an internal micro Serial ATA plug connector (hereinafter the Micro SATA plug) and an internal micro Serial ATA backplane connector (hereinafter the Micro SATA backplane) for mating with the Micro SATA plug in Pages 101-109.

The micro SATA plug has a signal segment and a power segment sharing a common base. The signal segment has a tongue portion extending from the common base for mating into the micro SATA backplane and seven signal contacts disposed in one side face of the tongue portion for delivering signals. The power segment has a tongue portion extending from the common base for mating into the micro SATA backplane and nine power contacts disposed in one side face of the tongue portion for delivering powers. The tongue portions of the signal segment and the power segment are coplanar and the contacts of the signal segment and the power segment are disposed on the same side of the tongue portions.

The micro SATA backplane has a signal segment and a power segment for mating with the signal segment and the power segment of the micro SATA plug. The signal segment and the power segment share a common insulated housing. The signal segment defines a slot in the housing for receiving the tongue portion of the signal segment of the micro SATA plug. The signal segment has seven signal contacts disposed in one inner side face of the slot for delivering signals. The power segment defines another slot in the housing besides the slot of the power segment for receiving the tongue portion of the power segment of the micro SATA plug. The power segment has nine power contacts (two of them are optional MFG pins) disposed in one inner side face of the slot for delivering powers.

However, the market demands new interfaces to increase the transfer speed of the micro SATA specification and compatible with the micro SATA plug and incompatible with micro SATA backplane.

### SUMMARY OF THE INVENTION

Accordingly, an object of the present invention is to provide electrical connectors providing interfaces compatible with internal micro Serial ATA connectors with higher transfer speed comparing the internal micro Serial ATA specification.

In order to achieve the object set fourth, an electrical connector providing interfaces compatible with internal micro Serial ATA connectors comprising an insulated housing, a first plurality of contacts assembled to the insulated housing and a second plurality of contacts assembled to the insulated housing. The first plurality of contacts constitute a power segment and a signal segment compatible with the internal micro Serial ATA connector. The second plurality of contacts are used for mating with a new type of mating connector when higher transfer speed is needed.

In order to achieve the object set fourth, an electrical connector assembly for connecting a storage device, comprising a first electrical connector and a second electrical connector is disclosed. The first electrical connector comprises a first insulated housing defining a longitudinal slot in a front face, the slot defining a first and a second inner side faces facing to each other, and the first and second inner side faces extending in a first direction perpendicular to the front face; a first plurality of contacts disposed in the first insulated housing and aligned along the first side face, the first plurality of contacts being compatible with an internal micro Serial ATA plug connector; and a second plurality of contacts disposed in the first insulated housing and aligned along the second inner side face. The second mating electrical connector comprises a second insulated housing having a base portion and an longitudinal tongue portion extending from a front face of the base portion along the first direction for mating into the slot of the first insulated housing, the tongue portion defining a first outer side face parallel to the first direction and a second outer side face opposite to the first side face; a first plurality of contacts assembled to the second insulated housing and aligned along the first outer side face for mating with the first plurality of contacts of the first electrical connector; and a second plurality of contacts assembled to the second insulated housing and aligned along the second outer side face for mating with the second plurality of contacts of the first electrical connector.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector assembly in accordance with the present invention;

FIG. 2 is a view similar to FIG. 1, except that the first electrical connector and the second electrical connector are unmated;

FIG. 3 is a view similar to FIG. 2, but viewed from a different aspect;

FIG. 4 is an exploded view of the first electrical connector; and

FIG. 5 is an exploded view of the second electrical connector.

### DETAILED DESCRIPTION OF THE INVENTION

Reference will now be made in detail to the preferred embodiment of the present invention.

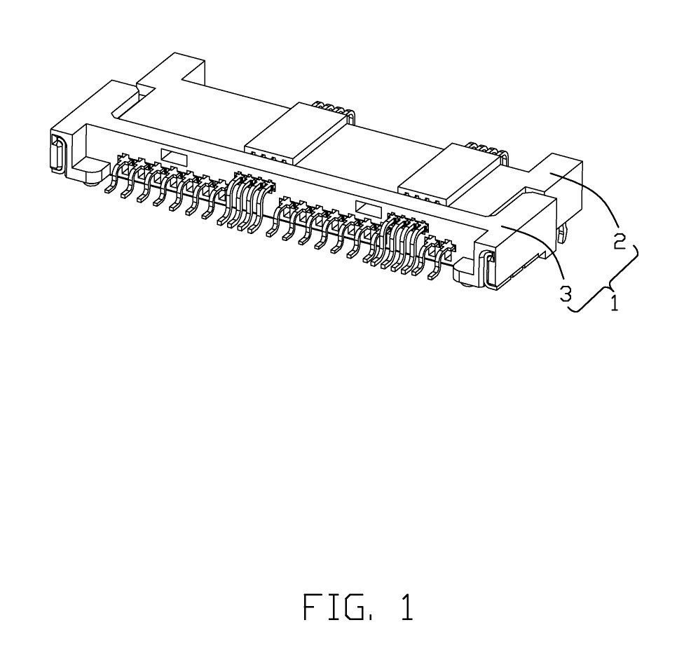

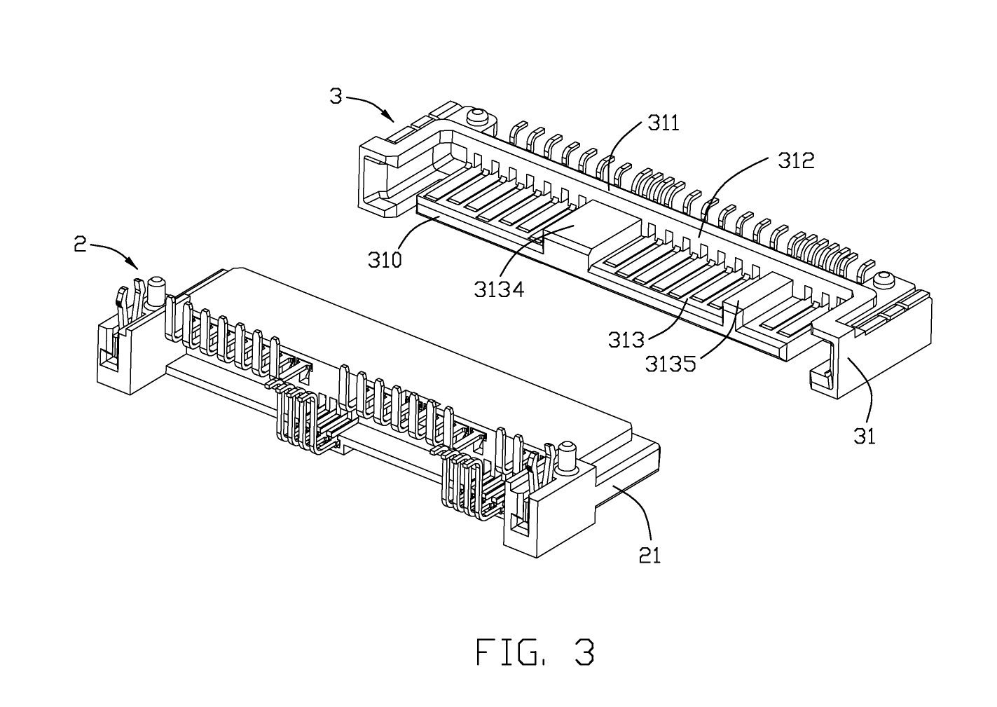

Referring to FIGS. 1-3, an electrical connector assembly 1 according to the present invention is shown. The electrical assembly 1 includes a first electrical connector 2 to be mounted on a first circuit board (not shown) and a second electrical connector 3 mounted on a second circuit board (not shown). The electrical connectors 100, 200 are used for providing interfaces for a storage device.

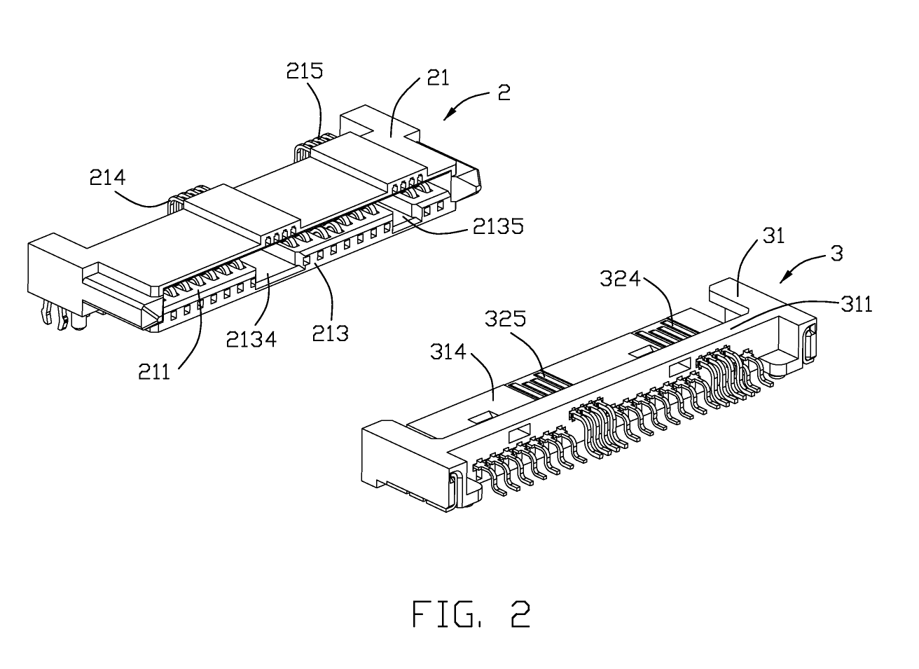

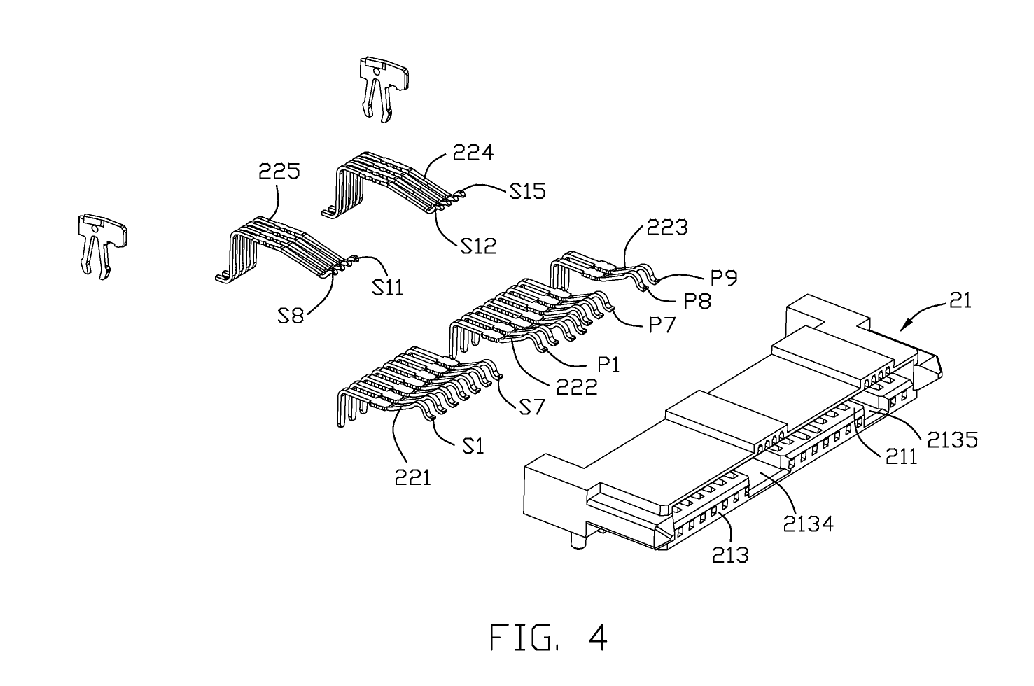

Referring to FIGS. 2-4, the first electrical connector 2 comprises a first insulated housing 21 defining a front face 213 and a first plurality of contacts S1-S7, P1-P9 assembled to the first insulated housing 21. The first insulated housing 21 defines a longitudinal slot 211 in the front face 213, the slot 211 having a first and a second inner side faces (not labeled) facing to each other, and the first and second inner side faces extending in a first direction perpendicular to the front face 213. The first plurality of contacts S1-S7, P1-P9 are aligned along the first side face, each of said contacts S1-S7, P1-P9 extending along the first direction for mating with the second electrical connector 3. The first inner side face of said slot 211 further defines two grooves 2134, 2135 extending along the first direction from the front face 213, said two grooves 2134, 2135 dividing the plurality of contacts S1-S7, P1-P9 into three groups 221, 222, 223. The three groups of contacts 221, 222, 223 are respectively named, in sequence, a third, a second and a first groups.

The slot 211 and the grooves 2134, 2135 are shaped compatible with an internal micro Serial ATA plug connector and the grooves prevents insertion of other Serial ATA cables. The first group of contacts 223 composes of two optional contacts P8, P9 for delivering power; the second group of contacts 222 composes of seven contacts P1-P7 for delivering power; the third group of contacts 221 composes of seven contacts S1-S7 for delivering signal, wherein the optional contacts P8, P9 are not used in some times, therefore a power segment and a signal segment are form within the first electrical connector 2.

The first electrical connector 2 further comprises a second plurality of contacts S8-S15 assembled to the first insulated housing 21 and aligned along the second side face, each of said second plurality of contacts S8-S15 extending along the first direction for mating with the second electrical connector 3. The second plurality of contacts compose of eight contacts S8-S15 and are divided into two groups, the fourth group 224, and the fifth group 225. The fourth group of the contacts 224 is aligned to the groove 2135 between the first group of contacts 223 and the second group of contacts 222 in a second direction perpendicular to the second side face. The fifth group of the contacts 225 is aligned to the groove 2134 between the second group of contacts 222 and the third group of contacts 221 in the second direction.

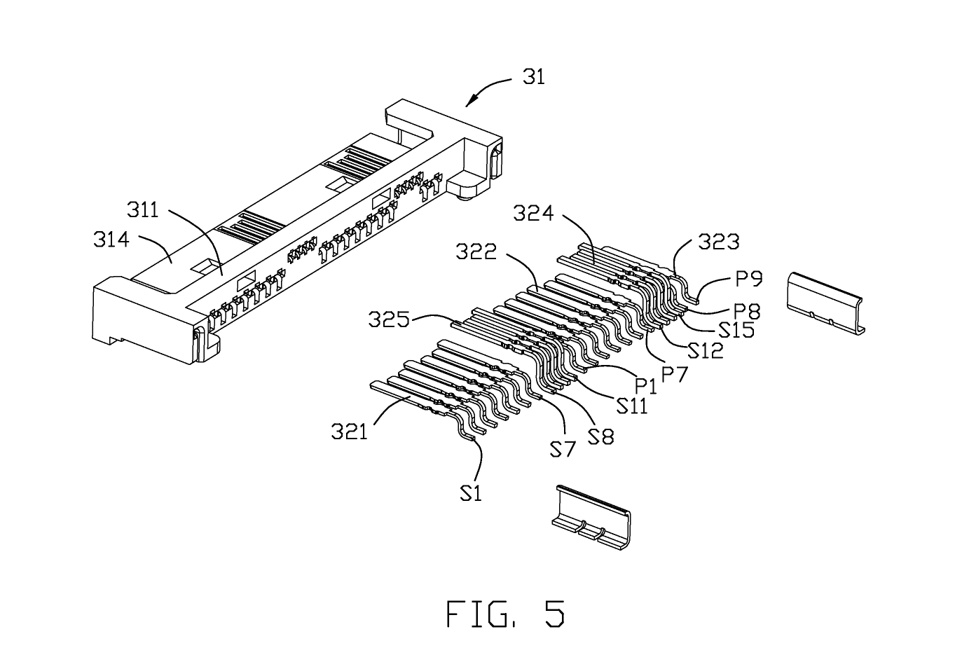

Referring to FIGS. 2, 3 and 5, the second electrical connector 3 in accordance with the present invention is shown. The second electrical connector 3 comprises a second insulated housing 31 and a first plurality of contacts S1-S7, P1-P9 assembled to the second insulated housing 31. The insulated housing 31 has a base portion 311 defining a front face 312 and an integral tongue portion 310 extending from the front face 312 along a first direction, the integral tongue portion 310 defining a first outer side face 313 parallel to the first direction and a second outer side face 314 opposite to the first side face 313. The first plurality of contacts S1-S7, P1-P9 are aligned along the first outer side face 313, each of said contacts S1-S7, P1-P9 extending along the first direction for respectively contacting the contacts S1-S7, P1-P9 of the first electrical connector 2. The integral tongue portion 310 forms two ribs 3134, 3135 on the first side face 313 of the integral tongue portion 310. The two ribs 3134, 3135 extend along the first direction from the front face 312 of the base portion 311 and divide the first plurality of contacts S1-S7, P1-P9 into three groups. The three groups of contacts S1-S7, P1-P9 are respectively named, in sequence, a first, a second and a third groups.

The second electrical connector 3 forms a power segment 262 having two groups of the contacts P1-P9 and a signal segment having one group of the contacts S1-S7. The contacts P1-P9, S11-S7 of power segment and the signal segment could be compatible with an internal micro Serial ATA backplane connector except that the rib 3134 prevents insertion of the electrical connector 3 into the internal micro Serial ATA backplane connector. The first group of contacts 323 composes of two optional contacts P8, P9 used for delivering power, wherein the optional contacts P8, P9 are not used in some times. The second group of contacts 322 composes of seven contacts P1-P7 used for delivering power. The third group of contacts 321 composes of seven contacts S1-S7 being used for delivering signal.

The second electrical connector 3 further comprises a second plurality of contacts 324, 325 shown in FIGS. 2, 3 and 5. The second plurality of contacts S8-S15 are aligned along the second outer side face 314, each of the second plurality of contacts S8-S15 extending along the first direction for mating with the first electrical connector 2. The second plurality of contacts compose of a fourth group of contacts 325 and a fifth group of contacts 325. The fourth group of contacts 325 comprises of four contacts S12-S15 and is aligned to the rib 3135 between the first group of contacts 323 and the second group of contacts 322. The fourth group of contacts 324 comprises of four contacts S8-S11 and is aligned to the rib 3134 between the second group of contacts 322 and the third group of contacts 321. Each of the first and the second pluralities of contact forms a soldering portion 328. The alignments of the fourth and the fifth groups of contacts 324, 325 with the ribs 3134, 3135 make that the soldering portions 328 of the contacts 321-325 can be arranged in a line.

So it could be drawn from the above description that the first electrical connector 2 is compatible with the second electrical connector 3 and the internal micro Serial ATA plug connector, while the second electrical connector 3 is incompatible with the internal micro Serial ATA backplane connector. In addition, the first and the second electrical connectors 2,3 add a secondary port at the internal micro Serial ATA connectors to increase the transfer speed. The second plurality of the contacts S8-S15 are specially arranged for higher transfer speed.

It is to be understood, however, that even though numerous characteristics and advantages of the present invention have been set fourth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

We claim:

1. An electrical connector providing an interface compatible with an internal micro Serial ATA connector, comprising:
an insulated housing;
a first plurality of contacts assembled to the insulated housing; and
a second plurality of contacts assembled to the insulated housing;
wherein the first plurality of contacts constitute a power segment and a signal segment compatible with the internal micro Serial ATA connector;
wherein said second plurality of contacts are used for mating with a new type of mating connector when higher transfer speed is needed.

2. The electrical connector as claimed in claim 1, wherein the insulated housing defines a slot in a front face thereof for receiving the mating connector, the slot defining a first and a second inner side faces facing to each other, the first plurality of contacts being disposed in the first inner side face and the second plurality of electrical connector being disposed in the second inner side face.

3. The electrical connector as claimed in claim 2, wherein said slot of the insulated housing is uninterrupted.

4. The electrical connector as claimed in claim 2, wherein the insulated housing defines two grooves in the first inner side face for preventing insertion of other Serial ATA connectors, said two grooves dividing the first plurality of contacts into, in sequence, a first, a second and a third groups, the first group of contacts consisting of two optional contacts belonging to the power segment, the second group of contacts consisting of seven contacts belonging to the power segment, the third group of contacts consisting of seven contacts belonging to the signal segment.

5. The electrical connector as claimed in claim 4, wherein the second plurality of contacts comprise a fourth group of contacts aligned to the groove between the first contacts and the second contacts in a direction perpendicular to the first inner side face.

6. The electrical connector as claimed in claim 5, wherein the second plurality of contacts further comprise a fifth group of contacts aligned to the groove between the second contacts and the third contacts in the direction perpendicular to the first inner side face.

7. The electrical connector as claimed in claim 5, wherein the fourth group of contacts comprises of four contacts and the fifth group of contacts comprise of four contacts.

8. The electrical connector as claimed in claim 1, wherein the insulated housing defines a front face and a tongue extending from the front face to be inserted into a mating connector, the tongue defining a fist and a second outer side faces opposite to each other, the first plurality of contacts being disposed in the first outer side face and the second plurality of electrical connector being disposed in the second outer side face.

9. The electrical connector as claimed in claim 8, wherein said tongue is uninterrupted in a direction parallel to the front face.

10. The electrical connector as claimed in claim 8, wherein the insulated housing protrudes two ribs on the first outer side face for preventing insertion into other Serial ATA backplanes, said two ribs dividing the first plurality of contacts into, in sequence, a first, a second and a third groups, the first group of contacts consisting of two optional contacts belonging to the power segment, the second group of contacts consisting of seven contacts belonging to the power segment, the third group of contacts consisting of seven contacts belonging to the signal segment.

11. The electrical connector as claimed in claim 10, wherein the second plurality of contacts comprise a fourth group of contacts aligned to the rib between the first group of contacts and the second group of contacts and a fifth group of contacts aligned to the rib between the second group of contacts and the third group of contacts in a direction perpendicular to the first outer side face.

12. The electrical connector as claimed in claim 11, wherein the fourth group of contacts comprises of four contacts and the fifth group of contacts comprises of four contacts.

13. The electrical connector as claimed in claim 12, wherein each contact of the first and the second pluralities of contacts comprises a soldering portion to be connected to a printed circuit board, said soldering portions being disposed in a line.

14. An electrical connector assembly for connecting a storage device, comprising:
a first electrical connector comprising:
a first insulated housing defining a longitudinal slot in a front face, the slot defining a first and a second inner side faces facing to each other, and the first and second inner side faces extending in a first direction perpendicular to the front face;
a first plurality of contacts disposed in the first insulated housing and aligned along the first side face, the first plurality of contacts being compatible with an internal micro Serial ATA plug connector;
a second plurality of contacts disposed in the first insulated housing and aligned along the second inner side face;
a second mating electrical connector comprising:
a second insulated housing having a base portion and an longitudinal tongue portion extending from a front face of the base portion along the first direction for mating into the slot of the first insulated housing, the tongue portion defining a first outer side face parallel to the first direction and a second outer side face opposite to the first side face;
a first plurality of contacts assembled to the second insulated housing and aligned along the first outer side face for mating with the first plurality of contacts of the first electrical connector;
a second plurality of contacts assembled to the second insulated housing and aligned along the second outer side face for mating with the second plurality of contacts of the first electrical connector.

15. The electrical connector assembly as claimed in claim 14, wherein the first electrical connector forms a power segment and a signal segment, the second plurality of contacts of the first electrical connector being divided into two groups respectively corresponding to the power and the signal segments, and wherein the second electrical connector forms a power segment and a signal segment for respectively mating with the power segment and the signal segment of the first electrical connector.

16. The electrical connector assembly as claimed in claim 14, wherein the power segment of the second electrical connector forms a first rib on the first outer side face of the tongue, the group of the second plurality of contacts corresponding to the power segment being aligning to the first rib in a direction perpendicular to the first outer side face, and wherein the signal segment of the second electrical connector forms a second rib on the first outer side face of the tongue, the group of second plurality of contacts corresponding to the signal segment being aligning to the second rib in the direction perpendicular to the first outer side face.

17. An electrical connector assembly comprising:
an insulative housing including an elongated base defining a lengthwise direction thereof and having a unitary mating tongue extending forwardly therefrom, said mating tongue including opposite first and second mating faces thereof;
first and second alignment ribs formed on the first face and spaced from each other along said lengthwise direction to divide said first face into three spaced different contact areas;
a group of first contacts disposed in the housing with first contacting sections positioned upon said three contact areas of first face; and
a group of second contacts disposed in the housing with second contacting sections positioned upon the second face around said first and second ribs to form two spaced contact regions; wherein
the first and second alignment ribs are dimension different from each other along said lengthwise direction while said two spaced contact regions are essentially equal to each other in said lengthwise direction under condition that a pitch of the contacting sections of said first contacts is larger than that of the second contacts.

18. The electrical connector assembly as claimed in claim 17, wherein said second face is further equipped with at least one recess which rearwardly communicates with an exterior via a through hole which extends therethrough the base.
